(19) United States
(12) Patent Application Publication
(10) Pub. No.: US 2017/0124652 A1
(43) Pub. Date: May 4, 2017

(54) PORTFOLIO OPTIMIZATION BY MEANS OF DELTA RATIO QUANTIFIED ESTIMATION ERROR

(71) Applicant: Andrew Macleod Beaven, Constantia (ZA)

(72) Inventor: Andrew Macleod Beaven, Constantia (ZA)

(21) Appl. No.: 14/929,717

(22) Filed: Nov. 2, 2015

(51) Int. Cl. G06Q 40/06

(52) U.S. Cl. CPC G06Q 40/06

(57) ABSTRACT

A computer-implemented method is used for selecting a portfolio weight (subject to specified constraints) for all assets in an optimal portfolio. An expected utility maximizing portfolio and a sample mean-variance efficient frontier are calculated. Multiple sets of optimization inputs are drawn from a distribution of simulated optimization inputs and an expected utility maximizing portfolio is computed for each set of optimization inputs. The risk and return properties of these resampled portfolios are used to compute a Delta ratio to identify the estimation error optimal portfolio and the risk tolerance necessary for this portfolio to be a sample efficient portfolio. Multiple sets of optimization inputs are drawn from a distribution of simulated optimization inputs, and using the identified risk tolerance, an expected utility maximizing portfolio is computed for each set of optimization inputs. The Delta ratio optimized portfolio is the mean of these resampled portfolios and determines investment of funds.

### TECHNICAL FIELD

This invention relates to the optimization of asset portfolios by determining optimally performing portfolio weights.

### BACKGROUND TO THE INVENTION

Managers of assets, such as portfolios of stocks, projects in a firm, or other assets, typically seek to maximize the expected or average return on an overall investment of funds for a given level of risk as defined in terms of variance of return, either historically or as adjusted using techniques known to persons skilled in portfolio management.

For any given set of portfolio weights, given by the column vector W, and given a column vector of asset mean returns R, the expected return for the portfolio ER can be computed by:

ER=W′R

For any given set of portfolio weights, given by the column vector W, and given a covariance matrix of asset returns Ω, the portfolio return variance VAR can be computed by:

VAR=W′ΩW

The portfolio risk is characterized as the return standard deviation, and this is given by the square root of the variance. Following the classical paradigm due to Markowitz, a portfolio may be optimized with the goal of deriving the peak average return for a given level of risk, in order to derive a so-called “mean-variance (MV) efficient” portfolio. This optimized portfolio is solved for using known techniques of linear or quadratic programming as appropriate. This optimized portfolio must obey any set of specified constraints, such as upper and lower boundaries for a weight on any given asset, and upper and lower boundaries for the sum of the portfolio weights. An “MV efficient frontier,” can be computed by solving for the portfolio weights for a number of fixed portfolio expected returns, such that the standard deviation of portfolio return associated with each of these fixed expected returns is minimized In many real world applications the optimized portfolio, is added to a fixed benchmark portfolio, this optimized portfolio generally referred to as an ‘active portfolio’.

Alternatively an optimized portfolio, consistent with any specified set of constraints, can be solved for by maximizing the mean-variance utility function given by: E[U_{MV}]=ER−ØVAR, where Ø is an investor specific risk aversion parameter. The portfolio weights that solve this maximization are consistent with the concept of Markowitz mean-variance (MV) efficient portfolios.

Known deficiencies of MV optimization as a practical tool for investment management include the instability and ambiguity of solutions. It is known that MV optimization may give rise to solutions which are both unstable with respect to small changes (within the uncertainties of the input parameters) and often non-intuitive. These MV optimized portfolios are thus of little investment sense or value for investment purposes and have poor out-of-sample average performance. These deficiencies are known to arise due to the propensity of MV optimization as “estimation-error maximizers,” as discussed in R. Michaud, “The Markowitz Optimization Enigma: Is Optimized Optimal?” Financial Analysts Journal (1989), which is herein incorporated by reference.

Resampling of a plurality of simulations of input data statistically consistent with an expected return and expected standard deviation of return has been applied (see, for example, Broadie, “Computing efficient frontiers using estimated parameters”, 45 Annals of Operations Research 21-58 (1993)) in efforts to overcome some of the statistical deficiencies inherent in use of sample moments alone. Comprehensive techniques based on a resampled efficient frontier are described in U.S. Pat. No. 6,003,018 (Michaud et al. '018), issued Dec. 14, 1999, and in U.S. Pat. No. 6,928,418 (Michaud et al. '418), issued Aug. 9, 2005. A book authored by R. Michaud, Efficient Asset Management, (Oxford University Press, 2008, hereinafter “Michaud 2008”), states that MV optimization is a statistical procedure, based on estimated returns subject to a statistical variance, and that, consequently, the MV efficient frontier, as defined above, is itself characterized by a variance.

The portfolio optimization approach taken by Michaud described in his book and patent documentation, is a method described by himself as “resampled efficiency”. Resampled efficiency is a method for bootstrapping an average resampled efficient frontier, and requires as a first step the generation of multivariate normal random numbers, the random number generation using as inputs the sample asset mean returns and the asset return covariance matrix. The random numbers thus produce a large number of subsamples, and for each subsample a set of MV efficient weights are solved for, and thus an efficient frontier is computed for each subsample. The portfolios weights for each ranked position on the subsampled efficient frontiers are averaged, and it is these averages that are termed ‘resampled efficient’. One of these averaged portfolios constitutes is deemed by Michaud to be the optimal portfolio, and recommended as a guide for investing funds. This ‘resampled optimal’ portfolio, is selected from the full set of resampled average portfolios by either: finding the resampled efficient portfolio that has the maximum Sharpe ratio, or that which is consistent with a risk target. Michaud's technique has been modified (2008) with the addition of variation in the asset mean returns used as inputs to the random number generation process. This methodology is the subject of U.S. Pat. No. 7,614,060 (Michaud et al. '060), issued Nov. 24, 2009 and is referred to by Michaud as ‘portfolio optimization by means of meta-resampled efficient frontiers’. The method of ‘resampled efficiency’ does not offer a method for selecting which of the average re-sampled efficient portfolios is the portfolio that will be invested in, this is a major shortcoming in Michaud's approach. In exhaustive theoretical simulations, it has been shown that ‘resampled efficiency’ does not improve out-of-sample performance, and has similar performance to standard MV optimized portfolios.

Although the goal of Michaud's average resampled portfolio weights is to bring out-of-sample performance metrics closer to in-sample performance metrics (which are maxima), this methodology does not explicitly model estimation error (the difference in the out-of-sample and in-sample metrics). The resampled efficient methodology is a heuristic which is entirely dependent on portfolio weight constraints. In the absence of constraints, the weights derived from resampled efficiency will equate to those derived by naive MV optimization. This dependence on constraints illustrates that in a purely mathematical sense, his invention does not address the extent to which sample error in the inputs is damaging to the process of computing optimal weights. In fact the less restrictive the constraints, the greater will be the estimation error in the portfolio weights, and the greater the expectation that a robust estimation process would deliver an improvement. But the result of “resampled efficiency” is that the greater the estimation error, the less effective it will be.

Although ‘resampled efficiency’ increases diversification relative to simple

MV optimized portfolios, the averaging of MV optimized portfolios via subsampling will lead to biased averages. The averaged ‘resample efficient’ portfolio has weights that are too great in absolute magnitude to maximize out-of-sample expected utility.

### SUMMARY OF THE INVENTION

According to a first aspect of the present invention, there is provided a computer-implemented method for selecting a value of a portfolio weight for each of a plurality of assets of an optimal portfolio, the value of portfolio weights chosen subject to prespecified upper and lower boundaries, and being subject to prespecified upper and lower boundaries for the value of the total portfolio weights, each asset characterized by an expected return, a standard deviation of return, and a covariance with respect to each other asset of the plurality of assets, the method comprising:

a. computing a utility function maximizing sample optimal portfolio W*ₛ using an investor specific risk aversion parameter Ø, portfolio weighted mean sample asset returns and portfolio weighted asset sample return covariances, as inputs to the utility function;

b. computing a sample optimal portfolio mean return ER*ₛ using W*ₛ and mean sample asset returns;

c. computing a sample optimal portfolio return variance VAR*ₛ using W*ₛ and asset sample return covariances;

d. computing a sample optimal portfolio certainty equivalent CEQ*ₛ using the expected utility of the sample optimal portfolio and the investor specific risk aversion parameter Ø;

e. computing a utility function maximizing portfolio using mean sample asset returns and asset return covariances for each of a plurality of alternative values for the risk aversion parameter a., to obtain a set of sample efficient portfolios W_{Many}^{Efficient} associated with the set of alternative risk aversion parameters Ø_{Many}^{Efficient};

f. computing a plurality of sample efficient portfolio mean returns ER_{Many}^{Efficient} with mean sample asset returns, each associated with a portfolio in the set W_{Many}^{Efficient};

g. generating a plurality of random asset return samples using mean sample asset returns and asset sample return covariances as inputs to a multivariate normal random number generator, said random asset return samples constituting a set of asset return resamples;

h. computing for each of the resamples an associated utility function maximizing portfolio using as inputs to the utility function, the investor specific risk aversion parameter Ø, portfolio weighted mean resample asset returns and portfolio weighted asset resample return covariances, as inputs to the utility function;

i. computing for each of the resamples an optimal resample portfolio mean return using the associated resample expected utility maximizing portfolio and the associated asset resample mean returns, giving a plurality of resample optimal portfolio mean returns ER_{Many}^{Resample};

j. computing for each of the resamples an optimal resample portfolio return variance using the associated resample expected utility maximizing portfolio and the associated asset resample return covariances, giving a plurality of resample optimal portfolio return variances VAR_{Many}^{Resample};

k. computing for each of the resamples an optimal resample portfolio sample mean return using the associated resample expected utility maximizing portfolio and mean sample asset returns, giving a plurality of resample optimal portfolio mean returns ER_{Many}^{Sample};

l. computing for each of the resamples an optimal resample portfolio return variance using the associated resample expected utility maximizing portfolio and asset sample return covariances, giving a plurality of resample optimal portfolio return variances VAR_{Many}^{Sample};

m. computing a sample optimal portfolio Delta ratio, using the formula,

$$Delta ratio = min \{ [ \frac{1}{{CEQ}_{s}^{*}} ] [ \frac{{M}^{2}}{4 V ∅} ] , 1 \}$$

$$where \text{:}$$

$$M = max ( {ER}_{s}^{*} - {Bias}_{mean} , 0 ) , \\ {Bias}_{mean} = max ( {R}_{xa} - {R}_{xp} , 0 ) , \\ {R}_{xa} = average value of {ER}_{Many}^{Resample} , \\ {R}_{xp} = average value of {ER}_{Many}^{Sample} , \\ V = {VAR}_{s}^{*} ( {Bias}_{variance} ) , and$$

$${Bias}_{variance} = \frac{average value of {VAR}_{Many}^{Sample}}{average value of {VAR}_{Many}^{Resample}} ;$$

scaling ER*ₛ by the Delta ratio to give a target sample portfolio mean return;

n. identifying the mean-equality portfolio, this portfolio belonging to the set W_{Many}^{Efficient} that has an associated mean return in the set ER_{Many}^{Efficient} that is closest to the target sample portfolio mean return;

o. computing a risk tolerance parameter such that the portfolio W_{SMSE} that maximizes the Quadratic Mean Square Error function:

ER_{SMSE}^{λ}−(VAR_{SMSE}+ER*_{SMSE})
where:
ER_{SMSE}=the portfolio W_{SMSE} sample mean return,
VAR_{SMSE}=the portfolio W_{SMSE} sample return variance,
has weights equal to the mean-equality portfolio;

p. computing for each of the resamples an associated Quadratic Mean Square Error function maximizing portfolio, using as inputs a resample portfolio mean return scaled by the risk tolerance parameter A. and a resample portfolio return variance, both computed from the associated resample asset returns, these portfolios constituting the set W_{Many}^{Optimal};

q. computing the average weighting to each asset from the portfolios in the set W_{Many}^{Optimal} to give the Delta Optimal Portfolio, this being the optimal portfolio.

The step of computing the sample optimal portfolio Delta ratio may further include moderating the Delta ratio to be a weighted average between the Delta ratio computed as described above and a supplementary Delta ratio which is computed using the formula,

$$Supplementary Delta ratio = min \{ \frac{{CEQ}_{x}}{{CEQ}_{s}^{*}} , 1 \}$$

$$where \text{:}$$

$${CEQ}_{x} = mv ( M ) - {∅ ( mv )}^{2} V , \\ M = max ( {ER}_{s}^{*} - {Bias}_{mean} , 0 ) , \\ {Bias}_{mean} = max ( {R}_{xa} - {R}_{xp} , 0 ) , \\ {R}_{xa} = average value of {ER}_{Many}^{Resample} , \\ {R}_{xp} = average value of {ER}_{Many}^{Sample} , \\ V = {VAR}_{s}^{*} ( {Bias}_{variance} ) , \\ {Bias}_{variance} = \frac{average value of {VAR}_{Many}^{Sample}}{average value of {VAR}_{Many}^{Resample}} , and$$

$$mv = min ( \frac{M}{2 ∅ V} , 1 ) ;$$

The utility function may be a mean-variance utility function.

The method may further comprise investing funds in accordance with the Delta Optimal Portfolio.

According to another aspect of the present invention there is provided a computer-implemented method for selecting a value of a portfolio weight for each of a plurality of assets of an optimal portfolio, the value of portfolio weights chosen subject to prespecified upper and lower boundaries, and being subject to prespecified upper and lower boundaries for the value of the total portfolio weights, each asset characterized by an expected return, a standard deviation of return and a covariance with respect to each other asset of the plurality of assets, the method comprising:

a. computing a utility function maximizing sample optimal portfolio W*ₛ using an investor specific risk aversion parameter Ø, portfolio weighted mean sample asset returns and portfolio weighted asset sample return covariances, as inputs to the utility function;

b. computing a sample optimal portfolio mean return ER*ₛ using W*ₛ and mean sample asset returns;

c. computing a sample optimal portfolio return variance VAR*ₛ using W*ₛ and asset sample return covariances;

d. computing a sample optimal portfolio certainty equivalent CEQ*ₛ

using the expected utility of the sample optimal portfolio and the investor specific risk aversion parameter Ø;

e. generating a plurality of random asset return samples using mean sample asset returns and asset sample return covariances as inputs to a multivariate normal random number generator, these random asset return samples constituting a set of asset return resamples;

f. computing for each of the resamples an associated utility function maximizing portfolio using as inputs to the utility function, the investor specific risk aversion parameter Ø, portfolio weighted mean resample asset returns and portfolio weighted asset resample return covariances, as inputs to the utility function;

g. computing for each of the resamples an optimal resample portfolio mean return using the associated resample expected utility maximizing portfolio and the associated asset resample mean returns, giving a plurality of resample optimal portfolio mean returns ER_{Many}^{Resample};

h. computing for each of the resamples an optimal resample portfolio return variance using the associated resample expected utility maximizing portfolio and the associated asset resample return covariances, giving a plurality of resample optimal portfolio return variances VAR_{Many}^{Resample};

i. computing for each of the resamples an optimal resample portfolio sample mean return using the associated resample expected utility maximizing portfolio and mean sample asset returns, giving a plurality of resample optimal portfolio mean returns ER_{Many}^{Sample};

j. computing for each of the resamples an optimal sample portfolio return variance using the associated resample expected utility maximizing portfolio and asset sample return covariances, giving a plurality of resample optimal portfolio return variances VAR_{Many}^{Sample};

k. computing a sample optimal portfolio Delta ratio using the formula,

$$Delta ratio = min \{ [ \frac{1}{{CEQ}_{s}^{*}} ] [ \frac{{M}^{2}}{4 V ∅} ] , 1 \}$$

$$where \text{:}$$

$$M = max ( {ER}_{s}^{*} - {Bias}_{mean} , 0 ) , \\ {Bias}_{mean} = max ( {R}_{xa} - {R}_{xp} , 0 ) , \\ {R}_{xa} = average value of {ER}_{Many}^{Resample} , \\ {R}_{xp} = average value of {ER}_{Many}^{Sample} , \\ V = {VAR}_{s}^{*} ( {Bias}_{variance} ) , and$$

$${Bias}_{variance} = \frac{average value of {VAR}_{Many}^{Sample}}{average value of {VAR}_{Many}^{Resample}} ;$$

l. Computing a Sample Diagonalized Covariance Matrix, said matrix being a modification of the sample asset return covariance matrix where the off-diagonal elements of the sample asset return covariance matrix are multiplied by the Delta ratio;

m. computing a utility function maximizing sample optimal portfolio W*_{sd} using as inputs to the utility function, the investor specific risk aversion parameter Ø, mean sample asset returns and the Sample Diagonalized Covariance Matrix;

n. computing a sample optimal portfolio mean return ER*_{sd} using W*_{sd} and mean sample asset returns;

o. computing a sample optimal portfolio return variance VAR*_{sd} using W*_{sd} and asset sample return covariances;

p. computing a sample optimal portfolio certainty equivalent CEQ*_{sd} using the expected utility of the sample optimal portfolio and the investor specific risk aversion parameter Ø;

q. computing a utility function maximizing portfolio using mean sample asset returns and the Sample Diagonalized Covariance Matrix for each of a plurality of alternative values for the risk aversion parameter Ø, to obtain a set of sample efficient portfolios W_{Many d}^{Efficient} associated with the set of alternative risk aversion parameters Ø_{Many}^{Efficient};

r. computing a plurality of sample efficient portfolio mean returns ER_{Many d}^{Efficient} with mean sample asset returns, each associated with a portfolio in the set W_{Many d}^{Efficient};

s. generating a plurality of random asset return samples using mean sample asset returns and asset sample return covariances as inputs to a multivariate normal random number generator, these random asset return samples constituting a set of asset return resamples;

t. computing for each of the resamples a Resample Diagonalized Covariance Matrix, each Resample Diagonalized Covariance Matrix being a modification of the associated resample asset return covariance matrix where the off-diagonal elements of the associated resample asset return covariance matrix are multiplied by the Delta ratio;

u. computing for each of the resamples an associated utility function maximizing portfolio using as inputs to the utility function, the investor specific risk aversion parameter Ø, the associated mean asset resample returns and the associated asset Resample Diagonalized Covariance Matrix;

v. computing for each of the resamples an optimal resample portfolio mean return using the associated resample expected utility maximizing portfolio and the associated asset resample mean returns, giving a plurality of resample optimal portfolio mean returns ER_{Many d}^{Resample};

w. computing for each of the resamples an optimal resample portfolio return variance using the associated resample expected utility maximizing portfolio and the associated asset resample return covariances, giving a plurality of resample optimal portfolio return variances V AR_{Many d}^{Resample};

x. computing for each of the resamples an optimal resample portfolio sample mean return using the associated resample expected utility maximizing portfolio and mean sample asset returns, giving a plurality of resample optimal portfolio mean returns ER_{Many d}^{Sample};

y. computing for each of the resamples an optimal sample portfolio return variance using the associated resample expected utility maximizing portfolio and asset sample return covariances, giving a plurality of resample optimal portfolio return variances VAR_{Many d}^{Sample};

z. computing the sample optimal portfolio Delta ratio using the formula,

$$Delta ratio = min \{ [ \frac{1}{{CEQ}_{s d}^{*}} ] [ \frac{{M}_{d}^{2}}{4 {V}_{d} ∅} ] , 1 \}$$

$$where \text{:}$$

$${M}_{d} = max ( {ER}_{s d}^{*} - {Bias}_{mean d} , 0 ) , \\ {Bias}_{mean d} = max ( {R}_{xad} - {R}_{xpd} , 0 ) , \\ {R}_{xad} = average value of {ER}_{Many d}^{Resample} , \\ {R}_{xpd} = average value of {ER}_{Many d}^{Sample} , \\ {V}_{d} = {VAR}_{sd}^{*} ( {Bias}_{variance d} ) , and$$

$${Bias}_{variance d} = \frac{average value of {VAR}_{Many d}^{Sample}}{average value of {VAR}_{Many d}^{Resample}} ;$$

aa. scaling ER*_{s d} by the Delta ratio to give a target sample portfolio mean return;

bb. identifying the portfolio in the set W_{Many d}^{Efficient} that has an associated mean return in the set ER_{Many d}^{Efficient} that is closest to the target sample portfolio mean return, this Delta Optimal Portfolio, being the optimal portfolio.

The step of computing the sample optimal portfolio Delta ratio may further include moderating the Delta ratio to be a weighted average between the Delta ratio computed as described above and a supplementary Delta ratio which is computed using the formula,

$$Supplementary Delta ratio = min \{ \frac{{CEQ}_{x}}{{CEQ}_{s}^{*}} , 1 \}$$

$$where \text{:}$$

$${CEQ}_{x} = mv ( M ) - {∅ ( mv )}^{2} V , \\ M = max ( {ER}_{s}^{*} - {Bias}_{mean} , 0 ) , \\ {Bias}_{mean} = max ( {R}_{xa} - {R}_{xp} , 0 ) , \\ {R}_{xa} = average value of {ER}_{Many}^{Resample} , \\ {R}_{xp} = average value of {ER}_{Many}^{Sample} , \\ V = {VAR}_{s}^{*} ( {Bias}_{variance} ) , \\ {Bias}_{variance} = \frac{average value of {VAR}_{Many}^{Sample}}{average value of {VAR}_{Many}^{Resample}} , and$$

$$mv = min ( \frac{M}{2 ∅ V} , 1 ) ;$$

The utility function may be a mean-variance utility function.

The method may further comprise investing funds in accordance with the Delta Optimal Portfolio.

According to a further aspect of the present invention there is provided a computer program product for use on a computer system for selecting a value of a portfolio weight for each of a plurality of assets of an optimal portfolio, the value of portfolio weights chosen subject to prespecified upper and lower boundaries, and being subject to prespecified upper and lower boundaries for the value of the total portfolio weights, each asset characterized by an expected return, a standard deviation of return, and a covariance with respect to each other asset of the plurality of assets, the computer program product a computer usable medium having computer readable program code thereon, the computer readable program code including:

a. program code for computing a utility function maximizing sample optimal portfolio W*ₛ using an investor specific risk aversion parameter Ø, portfolio weighted mean sample asset returns and portfolio weighted asset sample return covariances, as inputs to the utility function;

b. program code for computing a sample optimal portfolio mean return ER*ₛ using W*ₛ and mean sample asset returns;

c. program code for computing a sample optimal portfolio return variance VAR*ₛ using W*ₛ and asset sample return covariances;

d. program code for computing a sample optimal portfolio certainty equivalent CEQ*ₛ using the expected utility of the sample optimal portfolio and the investor specific risk aversion parameter Ø;

e. program code for computing a utility function maximizing portfolio using mean sample asset returns and asset return covariances for each of a plurality of alternative values for the risk aversion parameter Ø, to obtain a set of sample efficient portfolios W_{Many}^{Efficient} associated with the set of alternative risk aversion parameters Ø_{Many}^{Efficient};

f. program code for computing a plurality of sample efficient portfolio mean returns ER_{Many}^{Efficient} with mean sample asset returns, each associated with a portfolio in the set W_{Many}^{Efficient};

g. program code for generating a plurality of random asset return samples using mean sample asset returns and asset sample return covariances as inputs to a multivariate normal random number generator, said random asset return samples constituting a set of asset return resamples;

h. program code for computing for each of the resamples an associated utility function maximizing portfolio using as inputs to the utility function, the investor specific risk aversion parameter 0, portfolio weighted mean resample asset returns and portfolio weighted asset resample return covariances, as inputs to the utility function;

i. program code for computing for each of the resamples an optimal resample portfolio mean return using the associated resample expected utility maximizing portfolio and the associated asset resample mean returns, giving a plurality of resample optimal portfolio mean returns ER_{Many}^{Resample};

j. program code for computing for each of the resamples an optimal resample portfolio return variance using the associated resample expected utility maximizing portfolio and the associated asset resample return covariances, giving a plurality of resample optimal portfolio return variances VAR_{Many}^{Resample};

k. program code for computing for each of the resamples an optimal resample portfolio sample mean return using the associated resample expected utility maximizing portfolio and mean sample asset returns, giving a plurality of resample optimal portfolio mean returns ER_{Many}^{Sample};

l. program code for computing for each of the resamples an optimal resample portfolio return variance using the associated resample expected utility maximizing portfolio and asset sample return covariances, giving a plurality of resample optimal portfolio return variances VAR_{Many}^{Sample};

m. program code for computing a sample optimal portfolio Delta ratio, using the formula,

$$Delta ratio = min \{ [ \frac{1}{{CEQ}_{s}^{*}} ] [ \frac{{M}^{2}}{4 V ∅} ] , 1 \}$$

$$where \text{:}$$

$$M = max ( {ER}_{s}^{*} - {Bias}_{mean} , 0 ) , \\ {Bias}_{mean} = max ( {R}_{xa} - {R}_{xp} , 0 ) , \\ {R}_{xa} = average value of {ER}_{Many}^{Resample} , \\ {R}_{xp} = average value of {ER}_{Many}^{Sample} , \\ V = {VAR}_{s}^{*} ( {Bias}_{variance} ) , and$$

$${Bias}_{variance} - \frac{average value of {VAR}_{Many}^{Sample}}{average value of {VAR}_{Many}^{Resample}} ;$$

n. program code for scaling ER*ₛ by the Delta ratio to give a target sample portfolio mean return;

o. program code for identifying the mean-equality portfolio, this portfolio belonging to the set W_{Many}^{Efficient} that has an associated mean return in the set ER_{Many}^{Efficient} that is closest to the target sample portfolio mean return;

p. computing a risk tolerance parameter λ such that the portfolio W_{SMSE} that maximizes the Quadratic Mean Square Error function:

ER_{SMSE}λ−(VAR_{SMSE}+ER_{SMSE}²)

where:

ER_{SMSE}=the portfolio W_{SMSE} sample mean return,

VAR_{SMSE}=the portfolio W_{SMSE} sample return variance,

has weights equal to the mean-equality portfolio;

q. program code for computing for each of the resamples an associated Quadratic Mean Square Error function maximizing portfolio, using as inputs a resample portfolio mean return scaled by the risk tolerance parameter λ and a resample portfolio return variance, both computed from the associated resample asset returns, these portfolios constituting the set W_{Many}^{Optimal};

r. program code for computing the average weighting to each asset from the portfolios in the set W_{Many}^{Optimal} to give the Delta Optimal Portfolio, this being the optimal portfolio.

According to yet a further aspect of the present invention there is provided a computer program product for use on a computer system for selecting a value of a portfolio weight for each of a plurality of assets of an optimal portfolio, the value of portfolio weights chosen subject to prespecified upper and lower boundaries, and being subject to prespecified upper and lower boundaries for the value of the total portfolio weights, each asset characterized by an expected return, a standard deviation of return, and a covariance with respect to each other asset of the plurality of assets, the computer program product a computer usable medium having computer readable program code thereon, the computer readable program code including:

a. program code for computing a utility function maximizing sample optimal portfolio W*ₛ using an investor specific risk aversion parameter Ø, portfolio weighted mean sample asset returns and portfolio weighted asset sample return covariances, as inputs to the utility function;

b. program code for computing a sample optimal portfolio mean return ER*ₛ using W*ₛ and mean sample asset returns;

c. program code for computing a sample optimal portfolio return variance VAR*ₛ using W*ₛ and asset sample return covariances;

d. program code for computing a sample optimal portfolio certainty equivalent CEQ*ₛ using the expected utility of the sample optimal portfolio and the investor specific risk aversion parameter Ø;

e. program code for generating a plurality of random asset return samples using mean sample asset returns and asset sample return covariances as inputs to a multivariate normal random number generator, these random asset return samples constituting a set of asset return resamples;

f. program code for computing for each of the resamples an associated utility function maximizing portfolio using as inputs to the utility function, the investor specific risk aversion parameter 0, portfolio weighted mean resample asset returns and portfolio weighted asset resample return covariances, as inputs to the utility function;

g. program code for computing for each of the resamples an optimal resample portfolio mean return using the associated resample expected utility maximizing portfolio and the associated asset resample mean returns, giving a plurality of resample optimal portfolio mean returns ER_{Many}^{Resample};

h. program code for computing for each of the resamples an optimal resample portfolio return variance using the associated resample expected utility maximizing portfolio and the associated asset resample return covariances, giving a plurality of resample optimal portfolio return variances VAR_{Many}^{Resample};

i. program code for computing for each of the resamples an optimal resample portfolio sample mean return using the associated resample expected utility maximizing portfolio and mean sample asset returns, giving a plurality of resample optimal portfolio mean returns ER_{Many}^{Sample};

j. program code for computing for each of the resamples an optimal sample portfolio return variance using the associated resample expected utility maximizing portfolio and asset sample return covariances, giving a plurality of resample optimal portfolio return variances VAR_{Many}^{Sample};

k. program code for computing a sample optimal portfolio Delta ratio using the formula,

$$Delta ratio = min \{ [ \frac{1}{{CEQ}_{s}^{*}} ] [ \frac{{M}^{2}}{4 V ∅} ] , 1 \}$$

$$where \text{:}$$

$$M = max ( {ER}_{s}^{*} - {Bias}_{mean} , 0 ) , \\ {Bias}_{mean} = max ( {R}_{xa} - {R}_{xp} , 0 ) , \\ {R}_{xa} = average value of {ER}_{Many}^{Resample} , \\ {R}_{xp} = average value of {ER}_{Many}^{Sample} , \\ V = {VAR}_{s}^{*} ( {Bias}_{variance} ) , and$$

$${Bias}_{variance} = \frac{average value of {VAR}_{Many}^{Sample}}{average value of {VAR}_{Many}^{Resample}} ;$$

l. program code for computing a Sample Diagonalized Covariance Matrix, said matrix being a modification of the sample asset return covariance matrix where the off-diagonal elements of the sample asset return covariance matrix are multiplied by the Delta ratio;

m. program code for computing a utility function maximizing sample optimal portfolio W*_{s d} using as inputs to the utility function, the investor specific risk aversion parameter Ø, mean sample asset returns and the Sample Diagonalized Covariance Matrix;

n. program code for computing a sample optimal portfolio mean return ER*_{s d} using W*_{s d} and mean sample asset returns;

o. program code for computing a sample optimal portfolio return variance VAR*_{s d} using W*_{s d} and asset sample return covariances;

p. program code for computing a sample optimal portfolio certainty equivalent CEQ*_{s d} using the expected utility of the sample optimal portfolio and the investor specific risk aversion parameter Ø;

q. program code for computing a utility function maximizing portfolio using mean sample asset returns and the Sample Diagonalized Covariance Matrix for each of a plurality of alternative values for the risk aversion parameter Ø, to obtain a set of sample efficient portfolios W_{Many d}^{Efficient} associated with the set of alternative risk aversion parameters Ø_{Many}^{Efficient};

r. program code for computing a plurality of sample efficient portfolio mean returns ER_{Many d}^{Efficient} with mean sample asset returns, each associated with a portfolio in the set W_{Many d}^{Efficient};

s. program code for generating a plurality of random asset return samples using mean sample asset returns and asset sample return covariances as inputs to a multivariate normal random number generator, these random asset return samples constituting a set of asset return resamples;

t. program code for computing for each of the resamples a Resample Diagonalized Covariance Matrix, each Resample Diagonalized Covariance Matrix being a modification of the associated resample asset return covariance matrix where the off-diagonal elements of the associated resample asset return covariance matrix are multiplied by the Delta ratio;

u. program code for computing for each of the resamples an associated utility function maximizing portfolio using as inputs to the utility function, the investor specific risk aversion parameter 0, the associated mean asset resample returns and the associated asset Resample Diagonalized Covariance Matrix;

v. program code for computing for each of the resamples an optimal resample portfolio mean return using the associated resample expected utility maximizing portfolio and the associated asset resample mean returns, giving a plurality of resample optimal portfolio mean returns ER_{Many d}^{Resample};

w. program code for computing for each of the resamples an optimal resample portfolio return variance using the associated resample expected utility maximizing portfolio and the associated asset resample return covariances, giving a plurality of resample optimal portfolio return variances VAR_{Many d}^{Resample};

x. program code for computing for each of the resamples an optimal resample portfolio sample mean return using the associated resample expected utility maximizing portfolio and mean sample asset returns, giving a plurality of resample optimal portfolio mean returns ER_{Many d}^{Sample};

y. program code for computing for each of the resamples an optimal sample portfolio return variance using the associated resample expected utility maximizing portfolio and asset sample return covariances, giving a plurality of resample optimal portfolio return variances VAR_{Many d}^{Sample};

z. program code for computing the sample optimal portfolio Delta ratio using the formula,

$$Delta ratio = min \{ [ \frac{1}{{CEQ}_{s d}^{*}} ] [ \frac{{M}_{d}^{2}}{4 {V}_{d} ∅} ] , 1 \}$$

$$where \text{:}$$

$${M}_{d} = max ( {ER}_{s d}^{*} - {Bias}_{mean d} , 0 ) , \\ {Bias}_{mean d} = max ( {R}_{xad} - {R}_{xpd} , 0 ) , \\ {R}_{xad} = average value of {ER}_{Many d}^{Resample} , \\ {R}_{xpd} = average value of {ER}_{Many d}^{Sample} , \\ {V}_{d} = {VAR}_{sd}^{*} ( {Bias}_{variance d} ) , and$$

$${Bias}_{variance d} = \frac{average value of {VAR}_{Many d}^{Sample}}{average value of {VAR}_{Many d}^{Resample}} ;$$

aa. a program code for scaling ER*_{s d} by the Delta ratio to give a target sample portfolio mean return;

bb. a program code for identifying the portfolio in the set W_{Many d}^{Efficient} that has an associated mean return in the set ER_{Many d}^{Efficient} that is closest to the target sample portfolio mean return, this Delta Optimal Portfolio, being the optimal portfolio.

The program code for computing the sample optimal portfolio Delta ratio may further include program code for moderating the Delta ratio to be a weighted average between the Delta ratio computed as described above and a supplementary Delta ratio which is computed using the formula,

$$Supplementary Delta ratio = min \{ \frac{{CEQ}_{x}}{{CEQ}_{s}^{*}} , 1 \}$$

$$where \text{:}$$

$${CEQ}_{x} = mv ( M ) - {∅ ( mv )}^{2} V , \\ M = max ( {ER}_{s}^{*} - {Bias}_{mean} , 0 ) , \\ {Bias}_{mean} = max ( {R}_{xa} - {R}_{xp} , 0 ) , \\ {R}_{xa} = average value of {ER}_{Many}^{Resample} , \\ {R}_{xp} = average value of {ER}_{Many}^{Sample} , \\ V = {VAR}_{s}^{*} ( {Bias}_{variance} ) , \\ {Bias}_{variance} = \frac{average value of {VAR}_{Many}^{Sample}}{average value of {VAR}_{Many}^{Resample}} , and$$

$$mv = min ( \frac{M}{2 ∅ V} , 1 ) ;$$

The utility function may be a mean-variance utility function.

The computer program product may further comprise program code investing funds in accordance with the Delta Optimal Portfolio.

### BRIEF DESCRIPTION OF THE DRAWINGS

The invention will be more readily understood from the following description by way of non-limiting example, read in conjunction with the accompanied drawings, in which:

FIG. 1 is a flow chart of a first method for determining an optimal portfolio and investing funds according to the present invention; and

FIG. 2 is a flow chart of a second method for determining an optimal portfolio and investing funds according to the present invention.

### DETAILED DESCRIPTION OF SPECIFIC EMBODIMENTS

The purpose of the present invention is to maximize out-of-sample portfolio performance, where performance is measured by expected utility. Where expected utility E[Uₘᵥ] is computed from portfolio expected or average return ER, portfolio return variance VAR and Ø is a risk aversion measure:

E[Uₘᵥ]=ER−ØVAR

The present invention maximizes the expected utility value by varying the portfolio weights: this gives portfolios with high mean return and low risk. The information required to construct this portfolio, lies in a probability distribution of returns for each of the risky assets. The portfolio weights are used to weight the asset return distributions, the summation of these weighted return distributions will give the probability distribution of the portfolio. The values ER and VAR represent the first two central moments of the portfolio return distribution. The key innovation of Delta optimization is the incorporation of estimation error in the VAR term via a parameter called the Delta ratio. The Delta ratio is a nonnegative fraction, and linearly scales a portfolio of risky assets.

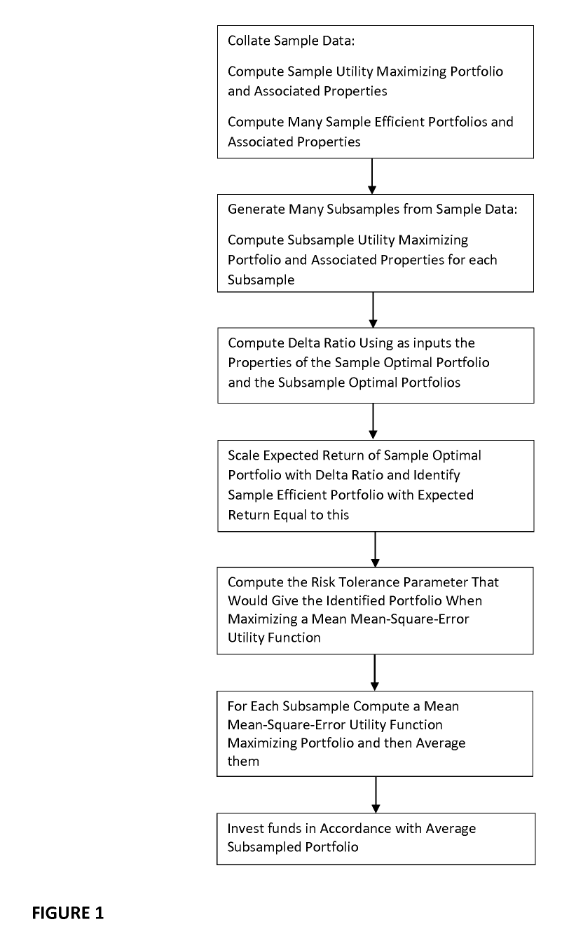

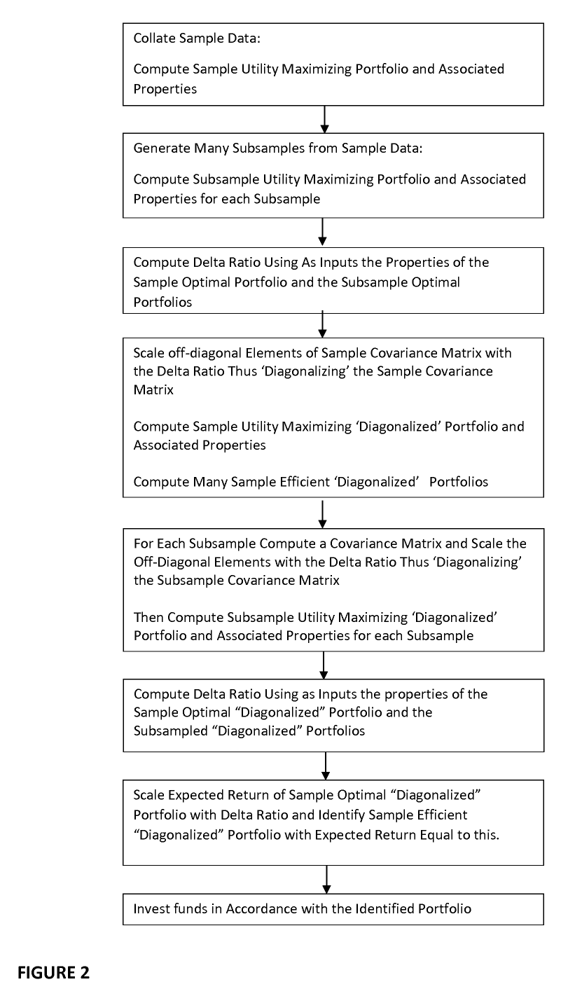

In Section 1 the portfolio optimization objective function and its required inputs are stated. Section 2 gives a brief discussion of the constraints that may restrict the portfolio weights in the process of optimization. Section 3 outlines the collection of asset return data, the process of computing the Delta ratio and the use of this ratio to find the optimal portfolio. This process is illustrated in FIG. 1. In Section 4 the Delta optimal portfolio is solved for in the case where the asset expected returns are dependent on the covariance structure of returns. The application of this work is to solve for estimation error optimized structural weights to the constituents of the market portfolio. This method incorporates a two stage bootstrap, the first stage having much in common with the method outlined in Section 3. The primary difference between this methodology and that in Section 3 is the first bootstrap solves a Delta ratio that is used to weight down the off-diagonal elements of the covariance matrix. This two-stage bootstrap is illustrated in FIG. 2. Section 5 provides understanding of Delta weights, given that the sum of the portfolio weights will typically require borrowing or lending with the risk-free asset.

### 1 Portfolio Optimization Objective Function

Given the column vector of asset mean returns R, a covariance matrix of asset returns Ω, and a column vector of portfolio weights W, the portfolio mean return ER=W′R, portfolio return variance VAR=W′ΩW, and the investor specific risk aversion parameter weighting Ø are used as inputs to the mean-variance utility function:

E[Uₘᵥ]=ER−ØVAR

The value E[Uₘᵥ] is referred to as portfolio expected utility. The portfolio mean-variance expected utility can be interpreted as a certainty equivalent, the certainty equivalent being the guaranteed return that would give the same expected utility as the portfolio expected utility. The value E[Uₘᵥ] is sought to be maximized by varying the portfolio weights, the solution weights to this optimization being referred to as a mean-variance optimal portfolio.

### 2 Portfolio Constraints

Portfolio weights are almost always subject to constraints, these constraints typically dictating that some or all asset weights, are subject to equality or inequality constraints. Additionally the sum of the weights may be subject to an equality constraint or an inequality constraint. In a classic capital allocation problem the sum of the portfolio weights is constrained to one. In the case of the active portfolio manager, that is the portfolio manager that seeks to outperform a benchmark portfolio, the portfolio manager seeks an optimal active portfolio, where the active portfolio is given by the difference between the portfolio weights and the benchmark portfolio weights. The sum of the active portfolio weights are typically, but not necessarily constrained to sum to zero. It is assumed that all portfolio optimizations conducted in the process of arriving at the Delta optimal portfolio honour these constraints.

### 3 The Present Invention Where Means are Independent of the Covariance Matrix

### 3.1 Sample Asset Returns

For all assets identified as being components of an optimal portfolio, a set of excess return data is collected. Excess return is given by subtracting the risk-free rate from the nominal asset return. This return data is hereafter referred to as the sample return data. Sample return data is characterized by means, standard deviations and correlations, and thus the assumption is made that the asset returns are normally distributed. A sample mean return vector R_{S}, and a sample return covariance matrix Ω_{S} are computed from the sample return data. For any given a set of sample portfolio weights W, the portfolio's sample expected return, or sample mean return is given by ER_{S}=W′R_{S}, the sample portfolio return variance is given by VARₛ=W′ΩₛW.

### 3.2 Sample Optimal Portfolios

The maximization of portfolio expected utility with sample return data will have as its solution a sample optimal portfolio W*_{S}. The optimal portfolio's expected return is given by ER*_{S}=W*′_{S}R_{S}, the portfolio return variance is given by VAR*_{S}=W*′_{S}Ω_{S}W*_{S}. The maximum expected utility is E[Uₘᵥ]*_{S}=ER*_{S} ØVAR*_{S}, and is interpreted as a certainty equivalent CEQ*_{S}. This solution may be termed naïve, in the sense that it will have low out-of-sample or realized performance, that is: having a realized expected return that is almost invariably much lower than ER*_{S}

and realized return variance much higher than VAR*_{S}. However, the portfolio W*_{S} provides a starting point for the Delta optimization process.

Additionally a large number of expected utility maximizing portfolios are generated, their variability being determined by parameterizing the utility function with risk aversion parameters varying from a number close to zero, to a large number (higher than the investor specific risk aversion). These portfolios are all efficient, being referred to as such due to the property that they all have maximum expected return for their respective return variances. This set of portfolios is denoted W_{Many}^{Efficient} having the associated set of expected returns ER_{Many}^{Efficient}.

### 3.3 Computing Delta Ratios

### 3.31 Resampling

The first step in computing the Delta ratio, is to conduct a Monte Carlo simulation to quantify the properties of the sample optimal portfolio W*_{S}. A multivariate normal random number generator with inputs R_{S} and Ω_{S} is used to generate a large number of samples of asset return data (say 1000). Hereafter referred to as resamples.

For each of the resamples, using resample data, an expected utility maximizing portfolio W*ₛ is computed using the investor specific risk aversion, in a way analogous to that that used to compute W*ₛ. Using the resample data an expected return ER*ₛ and a portfolio return variance VAR*ₛ is computed. The many resample optimal portfolios thus generate a set of resample expected returns giving the set denoted ER_{Many}^{Resample}, and a set of resample return variances VAR_{Many}^{Resample}. These values serving as analogs for sample expected returns and sample return variances in a population-sample experiment.

In addition, for each of the resamples, using the weights W*ₛ, and the sample mean return vector R_{S}, an expected return ERₛ is computed. For each of the resamples, using the weights W*ₛ and the sample covariance matrix Ω_{S} a portfolio return variance VARₛ is computed. The many resample optimal portfolios thus generate a set of sample expected returns giving the set denoted ER_{Many}^{Sample} and a set of resample return variances VAR_{Many}^{Sample}. The ERₛ values serving as analogs for population or out-of-sample expected returns and VARₛ values serving as analogs for population or out-of-sample variances in a population-sample experiment.

### 3.32 Computing Unbiased Estimators of Out-of-Sample Expected Return and Variance

Using the information provided from the resample optimizations from Section 3.31 above, an unbiased estimator of the out-of-sample expected return for the sample optimal portfolio Wican be computed. Firstly the expected return estimation error bias is computed via the difference in mean values:
BIASₘₑₐₙ=E(ER_{Many}^{Resample})−E(ER_{Many}^{Sample}). The estimation error bias is then subtracted from the sample optimal portfolio's expected return:
M=max(ER*_{S}−BIASₘₑₐₙ, 0) to give an unbiased estimator of the out-of-sample expected return for the sample optimal portfolio W*ₛ.

The unbiased estimator of the out-of-sample return variance for the sample optimal portfolio W*ₛ requires first computing the variance estimation error bias from the ratio of two means:

$${BIAS}_{variance} = \frac{E ( {VAR}_{Many}^{Sample} )}{E ( {VAR}_{Many}^{Resample} )} .$$

This estimation error bias is then used to scale the return variance of the sample optimal portfolio: V=(VAR*_{S})×(BIAS_{variance}).

### 3.33 Computing the Delta Ratio: Version 1

Using M, V and CEQ*ₛ, the Delta ratio is computed via the following formula:

$$Delta ratio = \{ [ \frac{{M}^{2}}{2 ∅ V} ] \frac{1}{2} \} \frac{1}{{CEQ}_{s}^{*}} \qquad ( Equation 1 )$$

### 3.34 Computing the Delta Ratio: Version 2

Using M and V, the ratio is computed:

$${MV}_{ratio} = \frac{M}{2 ∅ V }$$

Using this ratio together with CEQ*ₛ, the Delta ratio is computed via the following formula:

$$Delta ratio = \frac{M ( {MV}_{ratio} ) - ∅ {V ( {MV}_{ratio} )}^{2}}{{CEQ}_{s}^{*}} \qquad ( Equation 2 )$$

3.35 The Sample Optimal Portfolio with Estimation Error Corrected Mean Return

An unbiased expected return ER_{Delta} for the sample optimal portfolio W*_{S} is solved for by computing:

ER_{Delta}=Delta ratio ER*_{S}

where the Delta ratio is given by: Equation 1 or Equation 2, or a weighted average of the values given by Equation 1 or Equation 2. Note that the Delta ratio will always obey the equalities and inequalities: 0≦Delta ratio≦1. The value in the set ER_{Many}^{Efficient} that is closest to ER_{Delta} is identified, the portfolio in the set W_{Many}^{Efficient} associated with this identified expected return is selected. This selected portfolio is the sample Delta portfolio DW*. The expected return for the portfolio is given by DER*=DW*′R_{S} and the return variance is given by DVAR*=DW*′Ω_{S}DW*.

### 3.36 Solving for the Delta Optimal Portfolio

A risk tolerance parameter λ is solved for, such that the portfolio W_{SMSE} that maximizes the Quadratic Mean Square Error function:

ER_{SMSE}λ−(VAR_{SMSE}+ER_{SMSE}²) (Equation 3)

has portfolio weights equal to the portfolio DW*, and where:

ER_{SMSE}=W′_{SMSE}R_{S}, the sample portfolio mean return,

VAR_{SMSE}=W′_{SMSE}Ω_{S}W_{SMSE}, the sample portfolio return variance.

For each of the resamples of data previously generated (Section 3.31), using the risk tolerance parameter λ, a portfolio that maximizes the Quadratic Mean Square Error function given by Equation 3 is computed. A plurality of portfolios is thus generated, there being one associated for each resample of asset return data. The average of these weights is the Delta optimal portfolio. This method of computing resampled average portfolios differs to that generally advocated in the literature, where it is suggested that mean-variance optimal portfolios should be averaged. However the average mean-variance optimal portfolios are upwardly biased, that is they are not mean-variance optimal when evaluated using sample return data. By averaging resampled portfolios generated by maximizing a function in the form of Equation 3, this bias is avoided. Funds are invested according to the weights given by the Delta optimal portfolio.

4 The present invention Where Means are Dependent on the Covariance Matrix

The present invention, in the context of asset mean returns are in some way dependent on asset variances and covariances is outlined in this section, this solution differs to the process outlined above in Section 3. In the solution for the Delta optimal portfolio as outlined above in Section 3 there is an implicit assumption that the expected returns and the covariances are independent. To demonstrate this independence we assume that the structure of asset returns can be separated into independent sets of return:

r=Xb+e

where:

r=asset return

X=the set of variables that contain information about the future values of asset returns.

b=the weightings to the X variables that minimizes the forecast error e.

This is a regression framework, the important issue being the independence between the expected return Xb and the forecast error e components of return. However equilibrium asset returns as exemplified by expected returns generated by the capital asset pricing model are highly dependent on their variances and covariance with the market. Any form of dependence of asset returns on the covariance matrix will require the method outlined in this section to obtain a Delta optimal portfolio.

### 4.1 First Stage Bootstrap

In order to derive the Delta optimal portfolio weights where asset returns are dependent on asset return covariances a two stage bootstrap is necessary. The first stage has much in common with the method for computing the present invention explained in Section 3. The steps outlined in Section 3.1, Section 3.2, Section 3.3, Section 3.31, Section 3.32, Section 3.33, and Section 3.34 provide the first stage bootstrap (the only unnecessary step being the computing of a number of efficient portfolios discussed in Section 3.2).

### 4.2 Second Stage Bootstrap

The Delta ratio as given by Equation 1 or Equation 2, or a weighted average of these values, is used to ‘diagonalize’ the sample covariance matrix. The process of ‘diagonalizing’ a covariance matrix is that where the off-diagonal elements are scaled by the Delta ratio, thus creating what is termed the Sample Diagonalized Covariance Matrix Ω_{SDigonal}. This ‘diagonalizing’ in effect is a reduction in the correlation coefficients, this reduction in the influence of the correlations on the optimal portfolios reduces the Delta optimal portfolio's exposure to sample error in the correlations. Computing the portfolio expected return remains the same as that defined above: ER =W′R, where W is a column vector of portfolio weights and R is a column vector of asset mean returns.

### 4.21 Sample Optimal Portfolios

The computing of sample optimal portfolios with the Sample Diagonalized Covariance Matrix, is similar to that given in Section 3.2, but with Ω_{SDigonal} replacing Ω_{S}. The portfolio variance for any given portfolio W is then given by VAR=W′Ω_{SDiagonal}W. E[Uₘᵥ] as defined in Section 1 remains the maximand for the optimization, with the the expected utility maximizing portfolio again denoted W*_{S}.

The optimal portfolio's expected return is given by ER*_{S}=W*′_{S}R_{S}, the portfolio return variance is given by VAR*_{S}=W*′_{S}Ω_{SDiagonal}W*_{S}. The maximum expected utility is E[Uₘᵥ]*_{S}=ER*_{S}−ØVAR*_{S}, and is interpreted as a certainty equivalent CEQ*_{S}.

Additionally a large number of expected utility maximizing portfolios are generated, their variability being determined by parameterizing the utility function with risk aversion parameters varying from a number close to zero, to a large number (higher than the investor specific risk aversion). Again these portfolios differ to those given above in Section 3.2 only in that they are computed with the covariance matrix Ω_{SDiagonal}. These portfolios are all efficient, being referred to as such due to the property that they all have maximum expected return for their respective return variances. This set of portfolios is denoted W_{Many}^{Efficient} having the associated set of expected returns ER_{Many}^{Efficient}.

### 4.22 Computing Delta Ratios

### 4.22.1 Resampling

The first step in computing the Delta ratio, is to conduct a Monte Carlo simulation to quantify the properties of the sample optimal portfolio W*_{S}. A multivariate normal random number generator with inputs R_{S} and Ω_{S} is used to generate a large number of samples of asset return data (say 1000). Hereafter referred to as resamples.

For each of the resamples, using resample data a Resample Diagonalized Covariance Matrix Ω_{SDigonal} is computed, the off-diagonal elements being scaled by the same Delta ratio used to compute the Sample Diagonalized Covariance Matrix Ω_{SDigonal}. A resample expected utility portfolio W*ₛ is computed using the investor specific risk aversion, in a way analogous to that used to compute W*ₛ in Section 4.21. Using the resample data an expected return ER*ₛ, and a portfolio return variance VAR*ₛ is computed. The many resample optimal portfolios thus generate a set of resample expected returns giving the set denoted ER_{Many}^{Resample}, and a set of resample return variances VAR_{Many}^{Resample}. These values serving as analogs for sample expected returns and sample return variances in a population-sample experiment.

In addition, for each of the resamples, using the weights W*ₛ, and the sample mean return vector R_{S} an expected return ERₛ is computed. For each of the resamples, using the weights W*ₛ and the sample covariance matrix Ω_{S} (not Ω_{SDiagonal}) a portfolio return variance VARₛ is computed. The many resample optimal portfolios thus generate a set of sample expected returns giving the set denoted ER_{Many}^{Sample} and a set of resample return variances VAR_{Many}^{Sample}. The ERₛ and VARₛ values serving as analogs for population or out-of-sample expected returns and sample return variances respectively in a population-sample experiment.

### 4.22.2 Computing Unbiased Estimators of Out-of-Sample Expected Return and Variance

Using the information provided from the resample optimizations from Section 4.22.1 above an unbiased estimator of the out-of-sample expected return for the sample optimal portfolio W*_{S} can be computed. Firstly the expected return estimation error bias is computed via the difference in mean values:
BIASₘₑₐₙ=E(ER_{Many}^{Resample})−E(ER_{Many}^{Sample}). The estimation error bias is then subtracted from the sample optimal portfolio's expected return:
M=max(ER*_{S}−BIASₘₑₐₙ, 0) to give an unbiased estimator of the out-of-sample expected return for the sample optimal portfolio W*ₛ.

The unbiased estimator of the out-of-sample return variance for the sample optimal portfolio W*ₛ requires first computing the variance estimation error bias from the ratio of two means:

$${BIAS}_{variance} = \frac{E ( {VAR}_{Many}^{Sample} )}{E ( {VAR}_{Many}^{Resample} )} .$$

This estimation error bias is then used to scale the return variance of the sample optimal portfolio: V−(VAR*_{S})×(BIAS_{variance}).

### 4.22.3 Computing the Delta Ratio: Version 1

Using M, V and CEQ*ₛ, the Delta ratio is computed via the following formula:

$$Delta ratio = \{ [ \frac{{M}^{2}}{2 ∅V} ] \frac{1}{2} \} \frac{1}{{CEQ}_{s}^{*}} \qquad ( Equation 3 )$$

### 4.22.4 Computing the Delta Ratio: Version 2

Using M and V, the ratio is computed:

$${MV}_{ratio} = \frac{M}{2 ∅ V} .$$

Using this ratio together with CEQ*ₛ, the Delta ratio is computed via the following formula:

$$Delta ratio = \frac{M ( {MV}_{ratio} ) - ∅ {V ( {MV}_{ratio} )}^{2}}{{CEQ}_{s}^{*}} \qquad ( Equation 4 )$$

### 4.22.5 Solving for the Delta Optimal Portfolio

An unbiased expected return ER_{Delta} for the sample optimal portfolio W*_{S} is solved for by computing:

ER_{Delta}=Delta ratio ER*_{S}

where the Delta ratio is given by: Equation 3 or Equation 4, or a weighted average of the values given by Equation 1 or Equation 2. Note that the Delta ratio will always obey the equalities and inequalities: 0≦Delta ratio≦1. The value in the set ER_{Many}^{Efficient} that is closest to ER_{Delta} is identified, the portfolio in the set W_{Many}^{Efficient} associated with this identified expected return is selected. This selected portfolio is the sample Delta Optimal portfolio DW*. Funds are invested in accordance with the portfolio DW*.

### 5 Weight Interpretation: Allocation Between Risky Portfolio and Risk-Free Asset

Because the Delta Optimization is conducted with excess returns, the optimization explicitly optimizes the weightings to risky assets leaving the allocation to the risk-free asset as an implicit residual. If the investor has capital to invest then if the sum of the Delta optimal portfolios exceeds one, this requires that some funds be borrowed to invest fully in the Delta optimal portfolio. If the sum of the Delta optimal portfolios is less than one, then a positive fraction of the portfolio will be invested in the risk-free asset. Alternatively if the investor has no capital to invest then, if the sum of the Delta optimal portfolio weights is positive (negative), then the risk-free asset will have to be issued (then funds will be invested in the risk-free asset). The Delta optimal weights may be the solution to an active portfolio problem, that is, an optimization conducted by a portfolio manager who seeks to outperform a benchmark portfolio, so that the portfolio invested in is the sum of the Delta optimized active weights and the benchmark weights.

6 Benefits Over Prior Art

The present invention (in contrast to resampled efficiency proposed by Michaud et al) explicitly models estimation error of MV optimized portfolios via a ratio referred to as the Delta ratio. This ratio computes the estimation error squared that is implicitly added to the variance term in the mean-variance utility function. By increasing the portfolio variance for estimation error, the present invention will in general produce portfolios that have a higher weighting to the risk-free asset than resampled efficiency. This weighting to the risk-free asset will be greater, the lower the Sharpe ratio of the population, and the greater the number of assets being optimized. Furthermore the objective of the present invention is not to produce an efficient frontier—the outcome of Michaud's method, the objective of the present invention is to compute a single portfolio that is optimal for any given level of investor specific risk aversion. The primary reason for resampling in Michaud's method is to derive portfolio weights, whereas in the present invention, the primary reason for resampling is to quantify portfolio properties. The present invention seeks to identify the portfolio that will maximize expected utility for any given investor, not merely offer a set of portfolios that may be characterized as efficient. The crucial outcome of computing the Delta ratio is that a utility function lies at the core of the present invention. The use of a utility function as a portfolio optimization maximand ensures that when market opportunities are not attractive, the portfolio given by the present invention will be less risky, conversely if market opportunities are profitable then this portfolio will take on more risk. This is a significant achievement: most portfolio managers constrain portfolios to a risk target regardless of how attractive the current market conditions are, this is suboptimal behavior, and an acknowledgement that portfolio managers are unable to model estimation error.

The present invention has as its last step, computing an average portfolio produced by sub-sampling, but the use of moments—that is mean and mean-square error rather than central moments—produces a portfolio that does not have upwardly biased absolute weights.

The described embodiments of the invention are intended to be merely exemplary and numerous variations and modifications will be apparent to those skilled in the art. All such variations and modifications are intended to be within the scope of the present invention as defined in the appended claims.

What is claimed is:

1. A computer-implemented method for selecting a value of a portfolio weight for each of a plurality of assets of an optimal portfolio, the value of portfolio weights chosen subject to prespecified upper and lower boundaries, and being subject to prespecified upper and lower boundaries for the value of the total portfolio weights, each asset characterized by an expected return, a standard deviation of return, and a covariance with respect to each other asset of the plurality of assets, the method comprising:
a. computing a utility function maximizing sample optimal portfolio W*ₛ using an investor specific risk aversion parameter Ø, portfolio weighted mean sample asset returns and portfolio weighted asset sample return covariances, as inputs to the utility function;
b. computing a sample optimal portfolio mean return ER*ₛ using W*ₛ and mean sample asset returns;
c. computing a sample optimal portfolio return variance VAR*ₛ using W*ₛ and asset sample return covariances;
d. computing a sample optimal portfolio certainty equivalent CEQ*ₛ using the expected utility of the sample optimal portfolio and the investor specific risk aversion parameter Ø;
e. computing a utility function maximizing portfolio using mean sample asset returns and asset return covariances for each of a plurality of alternative values for the risk aversion parameter Ø, to obtain a set of sample efficient portfolios W_{Many}^{Efficient} associated with the set of alternative risk aversion parameters Ø_{Many}^{Efficient};
f. computing a plurality of sample efficient portfolio mean returns ER_{Many}^{Efficient} with mean sample asset returns, each associated with a portfolio in the set W_{Many}^{Efficient};
g. generating a plurality of random asset return samples using mean sample asset returns and asset sample return covariances as inputs to a multivariate normal random number generator, said random asset return samples constituting a set of asset return resamples;
h. computing for each of the resamples an associated utility function maximizing portfolio using as inputs to the utility function, the investor specific risk aversion parameter 0, portfolio weighted mean resample asset returns and portfolio weighted asset resample return covariances, as inputs to the utility function;
i. computing for each of the resamples an optimal resample portfolio mean return using the associated resample expected utility maximizing portfolio and the associated asset resample mean returns, giving a plurality of resample optimal portfolio mean returns ER_{Many}^{Resample};
j. computing for each of the resamples an optimal resample portfolio return variance using the associated resample expected utility maximizing portfolio and the associated asset resample return covariances, giving a plurality of resample optimal portfolio return variances VAR_{Many}^{Resample};
k. computing for each of the resamples an optimal resample portfolio sample mean return using the associated resample expected utility maximizing portfolio and mean sample asset returns, giving a plurality of res ample optimal portfolio mean returns ER_{Many}^{Sample};
l. computing for each of the resamples an optimal resample portfolio return variance using the associated resample expected utility maximizing portfolio and asset sample return covariances, giving a plurality of resample optimal portfolio return variances VAR_{Many}^{Sample};
m. computing a sample optimal portfolio Delta ratio, using the formula,
$$Delta ratio = min \{ [ \frac{1}{{CEQ}_{s}^{*}} ] [ \frac{{M}^{2}}{4 V ∅ } ] , 1 \}$$
$$where \text{:}$$
$$M = max ( {ER}_{s}^{*} - {Bias}_{mean} , 0 ) , \\ {Bias}_{mean} = max ( {R}_{xa} - {R}_{xp} , 0 ) , \\ {R}_{xa} = average value of {ER}_{Many}^{Resample} , \\ {R}_{xp} = average value of {ER}_{Many}^{Sample} , \\ V = {VAR}_{s}^{*} ( {Bias}_{variance} ) , and$$
$${Bias}_{variance} = \frac{average value of {VAR}_{Many}^{Sample}}{average value of {VAR}_{Many}^{Resample}} ;$$
n. scaling ER*ₛ by the Delta ratio to give a target sample portfolio mean return;
o. identifying the mean-equality portfolio, this portfolio belonging to the set W_{Many}^{Efficient} that has an associated mean return in the set ER_{Many}^{Efficient} that is closest to the target sample portfolio mean return;
p. computing a risk tolerance parameter λ such that the portfolio W_{SMSE} that maximizes the Quadratic Mean Square Error function:
ER_{SMSE}λ−(VAR_{SMSE}+ER_{SMSE}²)
where: ER_{SMSE}=the portfolio W_{SMSE} sample mean return,
VAR_{SMSE}=the portfolio sample return variance,
has weights equal to the mean-equality portfolio;
q. computing for each of the resamples an associated Quadratic Mean Square Error function maximizing portfolio, using as inputs a resample portfolio mean return scaled by the risk tolerance parameter k and a resample portfolio return variance, both computed from the associated resample asset returns, these portfolios constituting the set W_{Many}^{Optimal};
r. computing the average weighting to each asset from the portfolios in the set W_{Many}^{Optimal} to give the Delta Optimal Portfolio, this being the optimal portfolio.

2. A method according to claim 1, wherein the step of computing the sample optimal portfolio Delta ratio further includes moderating the Delta ratio to be a weighted average between the Delta ratio computed according to claim 1 and a supplementary Delta ratio which is computed using the formula,
$$Supplementary Delta ratio = min \{ \frac{{CEQ}_{x}}{{CEQ}_{s}^{*}} , 1 \}$$
$$where \text{:}$$
$${CEQ}_{x} = mv ( M ) - {∅ ( mv )}^{2} V , \\ M = max ( {ER}_{s}^{*} - {Bias}_{mean} , 0 ) , \\ {Bias}_{mean} = max ( {R}_{xa} - {R}_{xp} , 0 ) , \\ {R}_{xa} = average value of {ER}_{Many}^{Resample} , \\ {R}_{xp} = average value of {ER}_{Many}^{Sample} , \\ V = {VAR}_{s}^{*} ( {Bias}_{variance} ) , \\ {Bias}_{variance} = \frac{average value of {VAR}_{Many}^{Sample}}{average value of {VAR}_{Many}^{Resample}} , and$$
$$mv = min ( \frac{M}{2 ∅ V } , 1 ) ;$$

3. A method according to claim 1, wherein the utility function is a mean-variance utility function.

4. A method according to claim 2, wherein the utility function is a mean-variance utility function.

5. A method according to claim 1, further comprising investing funds in accordance with the Delta Optimal Portfolio.

6. A method according to claim 2, further comprising investing funds in accordance with the Delta Optimal Portfolio.

7. A method according to claim 3, further comprising investing funds in accordance with the Delta Optimal Portfolio.

8. A method according to claim 4, further comprising investing funds in accordance with the Delta Optimal Portfolio.

9. A computer-implemented method for selecting a value of a portfolio weight for each of a plurality of assets of an optimal portfolio, the value of portfolio weights chosen subject to prespecified upper and lower boundaries, and being subject to prespecified upper and lower boundaries for the value of the total portfolio weights, each asset characterized by an expected return, a standard deviation of return and a covariance with respect to each other asset of the plurality of assets, the method comprising:
a. computing a utility function maximizing sample optimal portfolio W*ₛ using an investor specific risk aversion parameter Ø, portfolio weighted mean sample asset returns and portfolio weighted asset sample return covariances, as inputs to the utility function;
b. computing a sample optimal portfolio mean return ER*ₛ using W*ₛ and mean sample asset returns;
c. computing a sample optimal portfolio return variance VAR*ₛ using W*ₛ and asset sample return covariances;
d. computing a sample optimal portfolio certainty equivalent CEQ*ₛ using the expected utility of the sample optimal portfolio and the investor specific risk aversion parameter Ø;
e. generating a plurality of random asset return samples using mean sample asset returns and asset sample return covariances as inputs to a multivariate normal random number generator, these random asset return samples constituting a set of asset return resamples;
f. computing for each of the resamples an associated utility function maximizing portfolio using as inputs to the utility function, the investor specific risk aversion parameter Ø, portfolio weighted mean resample asset returns and portfolio weighted asset resample return covariances, as inputs to the utility function;
g. computing for each of the resamples an optimal resample portfolio mean return using the associated resample expected utility maximizing portfolio and the associated asset resample mean returns, giving a plurality of resample optimal portfolio mean returns ER_{Many}^{Resample};
h. computing for each of the resamples an optimal resample portfolio return variance using the associated resample expected utility maximizing portfolio and the associated asset resample return covariances, giving a plurality of resample optimal portfolio return variances VAR_{Many}^{Resample};
i. computing for each of the resamples an optimal resample portfolio sample mean return using the associated resample expected utility maximizing portfolio and mean sample asset returns, giving a plurality of res ample optimal portfolio mean returns ER_{Many}^{Sample};
j. computing for each of the resamples an optimal sample portfolio return variance using the associated resample expected utility maximizing portfolio and asset sample return covariances, giving a plurality of resample optimal portfolio return variances VAR_{Many}^{Sample};
k. computing a sample optimal portfolio Delta ratio using the formula,
$$Delta ratio = min \{ [ \frac{1}{{CEQ}_{s}^{*}} ] [ \frac{{M}^{2}}{4 V ∅ } ] , 1 \}$$
$$where \text{:}$$
$$M = max ( {ER}_{s}^{*} - {Bias}_{mean} , 0 ) , \\ {Bias}_{mean} = max ( {R}_{xa} - {R}_{xp} , 0 ) , \\ {R}_{xa} = average value of {ER}_{Many}^{Resample} , \\ {R}_{xp} = average value of {ER}_{Many}^{Sample} , \\ V = {VAR}_{s}^{*} ( {Bias}_{variance} ) , and$$
$${Bias}_{variance} = \frac{average value of {VAR}_{Many}^{Sample}}{average value of {VAR}_{Many}^{Resample}} ;$$
l. Computing a Sample Diagonalized Covariance Matrix, said matrix being a modification of the sample asset return covariance matrix where the off-diagonal elements of the sample asset return covariance matrix are multiplied by the Delta ratio;
m. computing a utility function maximizing sample optimal portfolio W*_{s d} using as inputs to the utility function, the investor specific risk aversion parameter 0, mean sample asset returns and the Sample Diagonalized Covariance Matrix;
n. computing a sample optimal portfolio mean return ER*_{s d} using W*_{s d} and mean sample asset returns;
o. computing a sample optimal portfolio return variance VAR*_{s d} using W*_{s d} and asset sample return covariances;
p. computing a sample optimal portfolio certainty equivalent CEQ*_{s d} using the expected utility of the sample optimal portfolio and the investor specific risk aversion parameter Ø;
q. computing a utility function maximizing portfolio using mean sample asset returns and the Sample Diagonalized Covariance Matrix for each of a plurality of alternative values for the risk aversion parameter Ø, to obtain a set of sample efficient portfolios W_{Many d}^{Efficient} associated with the set of alternative risk aversion parameters Ø_{Many}^{Efficient};
r. computing a plurality of sample efficient portfolio mean returns ER_{Many d}^{Efficient} with mean sample asset returns, each associated with a portfolio in the set W_{Many d}^{Efficient};
s. generating a plurality of random asset return samples using mean sample asset returns and asset sample return covariances as inputs to a multivariate normal random number generator, these random asset return samples constituting a set of asset return resamples;
t. computing for each of the resamples a Resample Diagonalized Covariance Matrix, each Resample Diagonalized Covariance Matrix being a modification of the associated resample asset return covariance matrix where the off-diagonal elements of the associated resample asset return covariance matrix are multiplied by the Delta ratio;
u. computing for each of the resamples an associated utility function maximizing portfolio using as inputs to the utility function, the investor specific risk aversion parameter Ø, the associated mean asset resample returns and the associated asset Resample Diagonalized Covariance Matrix;
v. computing for each of the resamples an optimal resample portfolio mean return using the associated resample expected utility maximizing portfolio and the associated asset resample mean returns, giving a plurality of resample optimal portfolio mean returns ER_{Many d}^{Resample};
w. computing for each of the resamples an optimal resample portfolio return variance using the associated resample expected utility maximizing portfolio and the associated asset resample return covariances, giving a plurality of resample optimal portfolio return variances VAR_{Many d}^{Resample};
x. computing for each of the resamples an optimal resample portfolio sample mean return using the associated resample expected utility maximizing portfolio and mean sample asset returns, giving a plurality of resample optimal portfolio mean returns ER_{Many d}^{Sample};
y. computing for each of the resamples an optimal sample portfolio return variance using the associated resample expected utility maximizing portfolio and asset sample return covariances, giving a plurality of resample optimal portfolio return variances VAR_{Many d}^{Sample};
z. computing the sample optimal portfolio Delta ratio using the formula,
$$Delta ratio = min \{ [ \frac{1}{{CEQ}_{s d}^{*}} ] [ \frac{{M}_{d}^{2}}{4 {V}_{d} ∅ } ] , 1 \}$$
$$where \text{:}$$
$${M}_{d} = max ( {ER}_{s d}^{*} - {Bias}_{mean d} , 0 ) , \\ {Bias}_{mean d} = max ( {R}_{xa d} - {R}_{xp d} , 0 ) , \\ {R}_{xa d} = average value of {ER}_{Many d}^{Resample} , \\ {R}_{xp d} = average value of {ER}_{Many d}^{Sample} , \\ {V}_{d} = {VAR}_{s d}^{*} ( {Bias}_{variance d} ) , and$$
$${Bias}_{variance d} = \frac{average value of {VAR}_{Many d}^{Sample}}{average value of {VAR}_{Many d}^{Resample}} ;$$
aa. scaling ER*_{s d} by the Delta ratio to give a target sample portfolio mean return;
bb. identifying the portfolio in the set W_{Many d}^{Efficient} that has an associated mean return in the set ER_{Many d}^{Efficient} that is closest to the target sample portfolio mean return, this Delta Optimal Portfolio, being the optimal portfolio.

10. A method according to claim 9, wherein the step of computing the sample optimal portfolio Delta ratio further includes moderating the Delta ratio to be a weighted average between the Delta ratio computed according to claim 6 and a supplementary Delta ratio which is computed using the formula,
$$Supplementary Delta ratio = min \{ \frac{{CEQ}_{x}}{{CEQ}_{s}^{*}} , 1 \}$$
$$where \text{:}$$
$${CEQ}_{x} = mv ( M ) - {∅ ( mv )}^{2} V , \\ M = max ( {ER}_{s}^{*} - {Bias}_{mean} , 0 ) , \\ {Bias}_{mean} = max ( {R}_{xa} - {R}_{xp} , 0 ) , \\ {R}_{xa} = average value of {ER}_{Many}^{Resample} , \\ {R}_{xp} = average value of {ER}_{Many}^{Sample} , \\ V = {VAR}_{s}^{*} ( {Bias}_{variance} ) , \\ {Bias}_{variance} = \frac{average value of {VAR}_{Many}^{Sample}}{average value of {VAR}_{Many}^{Resample}} , and$$
$$mv = min ( \frac{M}{2 ∅ V } , 1 ) ;$$

11. A method according to claim 9, wherein the utility function is a mean-variance utility function.

12. A method according to claim 10, wherein the utility function is a mean-variance utility function.

13. A method according to claim 9, further comprising investing funds in accordance with the Delta Optimal Portfolio.

14. A method according to claim 10, further comprising investing funds in accordance with the Delta Optimal Portfolio.

15. A method according to claim 11, further comprising investing funds in accordance with the Delta Optimal Portfolio.

16. A method according to claim 12, further comprising investing funds in accordance with the Delta Optimal Portfolio.

17. A computer program product for use on a computer system for selecting a value of a portfolio weight for each of a plurality of assets of an optimal portfolio, the value of portfolio weights chosen subject to prespecified upper and lower boundaries, and being subject to prespecified upper and lower boundaries for the value of the total portfolio weights, each asset characterized by an expected return, a standard deviation of return, and a covariance with respect to each other asset of the plurality of assets, the computer program product a computer usable medium having computer readable program code thereon, the computer readable program code including:
a. program code for computing a utility function maximizing sample optimal portfolio W*ₛ using an investor specific risk aversion parameter Ø, portfolio weighted mean sample asset returns and portfolio weighted asset sample return covariances, as inputs to the utility function;
b. program code for computing a sample optimal portfolio mean return ER*ₛ using W*ₛ and mean sample asset returns;
c. program code for computing a sample optimal portfolio return variance VAR*ₛ using W*ₛ and asset sample return covariances;
d. program code for computing a sample optimal portfolio certainty equivalent CEQ*ₛ using the expected utility of the sample optimal portfolio and the investor specific risk aversion parameter Ø;
e. program code for computing a utility function maximizing portfolio using mean sample asset returns and asset return covariances for each of a plurality of alternative values for the risk aversion parameter Ø, to obtain a set of sample efficient portfolios W_{Many}^{Efficient} associated with the set of alternative risk aversion parameters Ø_{Many}^{Efficient};
f. program code for computing a plurality of sample efficient portfolio mean returns ER_{Many}^{Efficient} with mean sample asset returns, each associated with a portfolio in the set W_{Many}^{Efficient};
g. program code for generating a plurality of random asset return samples using mean sample asset returns and asset sample return covariances as inputs to a multivariate normal random number generator, said random asset return samples constituting a set of asset return resamples;
h. program code for computing for each of the resamples an associated utility function maximizing portfolio using as inputs to the utility function, the investor specific risk aversion parameter Ø, portfolio weighted mean resample asset returns and portfolio weighted asset resample return covariances, as inputs to the utility function;
i. program code for computing for each of the resamples an optimal resample portfolio mean return using the associated resample expected utility maximizing portfolio and the associated asset resample mean returns, giving a plurality of resample optimal portfolio mean returns ER_{Many}^{Resample};
j. program code for computing for each of the resamples an optimal resample portfolio return variance using the associated resample expected utility maximizing portfolio and the associated asset resample return covariances, giving a plurality of resample optimal portfolio return variances VAR_{Many}^{Resample};
k. program code for computing for each of the resamples an optimal resample portfolio sample mean return using the associated resample expected utility maximizing portfolio and mean sample asset returns, giving a plurality of resample optimal portfolio mean returns ER_{Many}^{Sample};
l. program code for computing for each of the resamples an optimal resample portfolio return variance using the associated resample expected utility maximizing portfolio and asset sample return covariances, giving a plurality of resample optimal portfolio return variances VAR_{Many}^{Sample};
m. program code for computing a sample optimal portfolio Delta ratio, using the formula,
$$Delta ratio = min \{ [ \frac{1}{{CEQ}_{s}^{*}} ] [ \frac{{M}^{2}}{4 V ∅ } ] , 1 \}$$
$$where \text{:}$$
$$M = max ( {ER}_{s}^{*} - {Bias}_{mean} , 0 ) , \\ {Bias}_{mean} = max ( {R}_{xa} - {R}_{xp} , 0 ) , \\ {R}_{xa} = average value of {ER}_{Many}^{Resample} , \\ {R}_{xp} = average value of {ER}_{Many}^{Sample} , \\ V = {VAR}_{s}^{*} ( {Bias}_{variance} ) , and$$
$${Bias}_{variance} = \frac{average value of {VAR}_{Many}^{Sample}}{average value of {VAR}_{Many}^{Resample}} ;$$
n. program code for scaling ER*ₛ by the Delta ratio to give a target sample portfolio mean return;
o. program code for identifying the mean-equality portfolio, this portfolio belonging to the set W_{Many}^{Efficient} that has an associated mean return in the set ER_{Many}^{Efficient} that is closest to the target sample portfolio mean return;
p. program code for computing a risk tolerance parameter λ such that the portfolio W_{SMSE} that maximizes the Quadratic Mean Square Error function:
ER_{SMSE}λ−(VAR_{SMSE}+ER_{SMSE}²)
where:
ER_{SMSE}=the portfolio W_{SMSE} sample mean return,
VAR_{SMSE}=the portfolio W_{SMSE} sample return variance,
has weights equal to the mean-equality portfolio;
q. program code for computing for each of the resamples an associated Quadratic Mean Square Error function maximizing portfolio, using as inputs a resample portfolio mean return scaled by the risk tolerance parameter and a resample portfolio return variance, both computed from the associated resample asset returns, these portfolios constituting the set W_{Many}^{Optimal};
r. program code for computing the average weighting to each asset from the portfolios in the set W_{Many}^{Optimal} to give the Delta Optimal Portfolio, this being the optimal portfolio.

18. A computer program product according to claim 17, wherein the program code for computing the sample optimal portfolio Delta ratio further includes program code for moderating the Delta ratio to be a weighted average between the Delta ratio computed according to claim 11 and a supplementary Delta ratio which is computed using the formula,
$$Supplementary Delta ratio = min \{ \frac{{CEQ}_{x}}{{CEQ}_{s}^{*}} , 1 \}$$
$$where \text{:}$$
$${CEQ}_{x} = mv ( M ) - {∅ ( mv )}^{2} V , \\ M = max ( {ER}_{s}^{*} - {Bias}_{mean} , 0 ) , \\ {Bias}_{mean} = max ( {R}_{xa} - {R}_{xp} , 0 ) , \\ {R}_{xa} = average value of {ER}_{Many}^{Resample} , \\ {R}_{xp} = average value of {ER}_{Many}^{Sample} , \\ V = {VAR}_{s}^{*} ( {Bias}_{variance} ) , \\ {Bias}_{variance} = \frac{average value of {VAR}_{Many}^{Sample}}{average value of {VAR}_{Many}^{Resample}} , and$$
$$mv = min ( \frac{M}{2 ∅ V } , 1 ) ;$$

19. A computer program product according to claim 17, wherein the utility function is a mean-variance utility function.

20. A computer program product according to claim 18, wherein the utility function is a mean-variance utility function.

21. A computer program product according to claim 17, which further comprises program code for investing funds in accordance with the Delta Optimal Portfolio.

22. A computer program product according to claim 18, which further comprises program code for investing funds in accordance with the Delta Optimal Portfolio.

23. A computer program product according to claim 19, which further comprises program code for investing funds in accordance with the Delta Optimal Portfolio.

24. A computer program product according to claim 20, which further comprises program code for investing funds in accordance with the Delta Optimal Portfolio.

25. A computer program product for use on a computer system for selecting a value of a portfolio weight for each of a plurality of assets of an optimal portfolio, the value of portfolio weights chosen subject to prespecified upper and lower boundaries, and being subject to prespecified upper and lower boundaries for the value of the total portfolio weights, each asset characterized by an expected return, a standard deviation of return, and a covariance with respect to each other asset of the plurality of assets, the computer program product a computer usable medium having computer readable program code thereon, the computer readable program code including:
a. program code for computing a utility function maximizing sample optimal portfolio W*ₛ using an investor specific risk aversion parameter Ø, portfolio weighted mean sample asset returns and portfolio weighted asset sample return covariances, as inputs to the utility function;
b. program code for computing a sample optimal portfolio mean return ER*ₛ using W*ₛ and mean sample asset returns;
c. program code for computing a sample optimal portfolio return variance VAR*ₛ using W*ₛ and asset sample return covariances;
d. program code for computing a sample optimal portfolio certainty equivalent CEQ*ₛ using the expected utility of the sample optimal portfolio and the investor specific risk aversion parameter Ø;
e. program code for generating a plurality of random asset return samples using mean sample asset returns and asset sample return covariances as inputs to a multivariate normal random number generator, these random asset return samples constituting a set of asset return resamples;
f. program code for computing for each of the resamples an associated utility function maximizing portfolio using as inputs to the utility function, the investor specific risk aversion parameter Ø, portfolio weighted mean resample asset returns and portfolio weighted asset resample return covariances, as inputs to the utility function;
g. program code for computing for each of the resamples an optimal resample portfolio mean return using the associated resample expected utility maximizing portfolio and the associated asset resample mean returns, giving a plurality of resample optimal portfolio mean returns ER_{Many}^{Resample};
h. program code for computing for each of the resamples an optimal resample portfolio return variance using the associated resample expected utility maximizing portfolio and the associated asset resample return covariances, giving a plurality of resample optimal portfolio return variances VAR_{Many}^{Resample};
i. program code for computing for each of the resamples an optimal resample portfolio sample mean return using the associated resample expected utility maximizing portfolio and mean sample asset returns, giving a plurality of resample optimal portfolio mean returns ER_{Many}^{Sample};
j. program code for computing for each of the resamples an optimal sample portfolio return variance using the associated resample expected utility maximizing portfolio and asset sample return covariances, giving a plurality of resample optimal portfolio return variances VAR_{Many}^{Sample};
k. program code for computing a sample optimal portfolio Delta ratio using the formula,
$$Delta ratio = min \{ [ \frac{1}{{CEQ}_{s}^{*}} ] [ \frac{{M}^{2}}{4 V ∅ } ] , 1 \}$$
$$where \text{:}$$
$$M = max ( {ER}_{s}^{*} - {Bias}_{mean} , 0 ) , \\ {Bias}_{mean} = max ( {R}_{xa} - {R}_{xp} , 0 ) , \\ {R}_{xa} = average value of {ER}_{Many}^{Resample} , \\ {R}_{xp} = average value of {ER}_{Many}^{Sample} , \\ V = {VAR}_{s}^{*} ( {Bias}_{variance} ) , and$$
$${Bias}_{variance} = \frac{average value of {VAR}_{Many}^{Sample}}{average value of {VAR}_{Many}^{Resample}} ;$$
l. program code for computing a Sample Diagonalized Covariance Matrix, said matrix being a modification of the sample asset return covariance matrix where the off-diagonal elements of the sample asset return covariance matrix are multiplied by the Delta ratio;
m. program code for computing a utility function maximizing sample optimal portfolio W*_{s d}using as inputs to the utility function, the investor specific risk aversion parameter Ø, mean sample asset returns and the Sample Diagonalized Covariance Matrix;
n. program code for computing a sample optimal portfolio mean return ER*_{s d} using W*_{s d} and mean sample asset returns;
o. program code for computing a sample optimal portfolio return variance VAR*_{s d} using W*_{s d} and asset sample return covariances;
p. program code for computing a sample optimal portfolio certainty equivalent CEQ*_{s d} using the expected utility of the sample optimal portfolio and the investor specific risk aversion parameter Ø;
q. program code for computing a utility function maximizing portfolio using mean sample asset returns and the Sample Diagonalized Covariance Matrix for each of a plurality of alternative values for the risk aversion parameter Ø, to obtain a set of sample efficient portfolios W_{Many d}^{Efficient} associated with the set of alternative risk aversion parameters Ø_{Many}^{Efficient};
r. program code for computing a plurality of sample efficient portfolio mean returns ER_{Many d}^{Efficient} with mean sample asset returns, each associated with a portfolio in the set W_{Many d}^{Efficient};
s. program code for generating a plurality of random asset return samples using mean sample asset returns and asset sample return covariances as inputs to a multivariate normal random number generator, these random asset return samples constituting a set of asset return resamples;
t. program code for computing for each of the resamples a Resample Diagonalized Covariance Matrix, each Resample Diagonalized Covariance Matrix being a modification of the associated resample asset return covariance matrix where the off-diagonal elements of the associated resample asset return covariance matrix are multiplied by the Delta ratio;
u. program code for computing for each of the resamples an associated utility function maximizing portfolio using as inputs to the utility function, the investor specific risk aversion parameter Ø, the associated mean asset resample returns and the associated asset Resample Diagonalized Covariance Matrix;
v. program code for computing for each of the resamples an optimal resample portfolio mean return using the associated resample expected utility maximizing portfolio and the associated asset resample mean returns, giving a plurality of resample optimal portfolio mean returns ER_{Many d}^{Resample};
w. program code for computing for each of the resamples an optimal resample portfolio return variance using the associated resample expected utility maximizing portfolio and the associated asset resample return covariances, giving a plurality of resample optimal portfolio return variances VAR_{Many d}^{Resample};
x. program code for computing for each of the resamples an optimal resample portfolio sample mean return using the associated resample expected utility maximizing portfolio and mean sample asset returns, giving a plurality of resample optimal portfolio mean returns ER_{Many d}^{Sample};
y. program code for computing for each of the resamples an optimal sample portfolio return variance using the associated resample expected utility maximizing portfolio and asset sample return covariances, giving a plurality of resample optimal portfolio return variances VAR_{Many d}^{Sample};
z. program code for computing the sample optimal portfolio Delta ratio using the formula,
$$Delta ratio = min \{ [ \frac{1}{{CEQ}_{s d}^{*}} ] [ \frac{{M}_{d}^{2}}{4 {V}_{d} ∅ } ] , 1 \}$$
$$where \text{:}$$
$${M}_{d} = max ( {ER}_{s d}^{*} - {Bias}_{mean d} , 0 ) , \\ {Bias}_{mean d} = max ( {R}_{xa d} - {R}_{xp d} , 0 ) , \\ {R}_{xa d} = average value of {ER}_{Many d}^{Resample} , \\ {R}_{xp d} = average value of {ER}_{Many d}^{Sample} , \\ {V}_{d} = {VAR}_{s d}^{*} ( {Bias}_{variance d} ) , and$$
$${Bias}_{variance d} = \frac{average value of {VAR}_{Many d}^{Sample}}{average value of {VAR}_{Many d}^{Resample}} ;$$
aa. a program code for scaling ER*_{s d} by the Delta ratio to give a target sample portfolio mean return;
bb. a program code for identifying the portfolio in the set W_{Many d}^{Efficient} that has an associated mean return in the set ER_{Many d}^{Efficient} that is closest to the target sample portfolio mean return, this Delta Optimal Portfolio, being the optimal portfolio.

26. A computer program product according to claim 25, wherein the program code for computing the sample optimal portfolio Delta ratio further includes program code for moderating the Delta ratio to be a weighted average between the Delta ratio computed according to claim 16 and a supplementary Delta ratio which is computed using the formula,
$$Supplementary Delta ratio = min \{ \frac{{CEQ}_{x}}{{CEQ}_{s}^{*}} , 1 \}$$
$$where \text{:}$$
$${CEQ}_{x} = mv ( M ) - {∅ ( mv )}^{2} V , \\ M = max ( {ER}_{s}^{*} - {Bias}_{mean} , 0 ) , \\ {Bias}_{mean} = max ( {R}_{xa} - {R}_{xp} , 0 ) , \\ {R}_{xa} = average value of {ER}_{Many}^{Resample} , \\ {R}_{xp} = average value of {ER}_{Many}^{Sample} , \\ V = {VAR}_{s}^{*} ( {Bias}_{variance} ) , \\ {Bias}_{variance} = \frac{average value of {VAR}_{Many}^{Sample}}{average value of {VAR}_{Many}^{Resample}} , and$$
$$mv = min ( \frac{M}{2 ∅ V } , 1 ) ;$$

27. A computer program product according to claim 25, wherein the utility function is a mean-variance utility function.

28. A computer program product according to claim 26, wherein the utility function is a mean-variance utility function.

29. A computer program product according to claim 25, which further comprises program code investing funds in accordance with the Delta Optimal Portfolio.

30. A computer program product according to claim 26, which further comprises program code investing funds in accordance with the Delta Optimal Portfolio.

31. A computer program product according to claim 27, which further comprises program code investing funds in accordance with the Delta Optimal Portfolio.

32. A computer program product according to claim 28, which further comprises program code investing funds in accordance with the Delta Optimal Portfolio.
